(19) United States
(12) Patent Application Publication
(10) Pub. No.: US 2008/0284831 A1
(43) Pub. Date: Nov. 20, 2008

(54) Cartridge for Inkjet Printer

(76) Inventor: Yang-Yun Zeng, Guangdoon (CN)

Correspondence Address: SCHULTE ROTH & ZABEL LLP;ATTN: JOEL E. LUTZKER, 919 THIRD AVENUE, NEW YORK, NY, 10022, US

(21) Appl. No.: 11/884,068

(22) PCT Filed: Mar. 21, 2006
(86) PCT No.: PCT/CN2006/000442

§ 371 Date: Apr. 29, 2008

(30) Foreign Application Priority Data
Jun. 4, 2005 (CN) 2005/520059632.1
Dec. 5, 2005 (CN) 2005/20142521.7

(51) Int. Cl. B41J 2/175

(52) U.S. Cl. 347/86

(57) ABSTRACT

An ink cartridge for an inkjet printer including an ink tank, a shelf, and a chip is provided. The ink tank has a handle, and two locking structures are disposed on the handle. One of the locking structures fits the shelf, and the other locking structure fits the printer. The ink tank has a pressure control valve mechanism for precisely controlling an internal negative pressure. The ink tank and the shelf are connected together with the locking structures. The chip is fixed on the shelf. Only the ink tank needs to be replaced. Thus, the resource is saved, and the cost is reduced.

### BACKGROUND OF THE INVENTION

1. Field of the Invention

The present invention relates to an ink cartridge for an inkjet printer.

2. Description of Related Art

Currently, some ink cartridges with chips for inkjet printers are available on market. When an ink cartridge is used out, ⅓-½ ink is often left in the ink cartridge. Usually, the chip and the ink cartridge are discarded together, which results in a high printing cost and also pollutes the environment.

### SUMMARY OF THE INVENTION

In view of the problem of high printing cost of the ink cartridges, the present invention is directed to provide an ink cartridge for an inkjet printer. The ink cartridge adopts a separate structure, and can be reused with the chip. Ink in the ink cartridge can be fully utilized, and little ink residual remains in the ink cartridge. Thus, the use cost of users is greatly reduced, and the environment is protected.

The objective of the present invention is realized as follows.

An ink cartridge for an inkjet printer comprises an ink tank, a shelf, and a chip, wherein the ink tank has at least one handle, and one of the handles has at least two locking structures, one of the locking structures fits the shelf, and the other fits the printer.

The ink tank has a pressure control valve mechanism for precisely controlling an internal negative pressure, the chip is fixed on the shelf, and the ink tank and the shelf are connected together with the locking structures.

The pressure control valve mechanism on the ink tank comprises a valve membrane, a spring, and a valve body.

The locking structures on the handle of the present invention ensure the close fit between the printer and the ink cartridge, and the chip can be reused.

### BRIEF DESCRIPTION OF THE DRAWINGS

FIG. 1 is an isometric view of the shelf.

FIG. 2 is an isometric view of the ink tank.

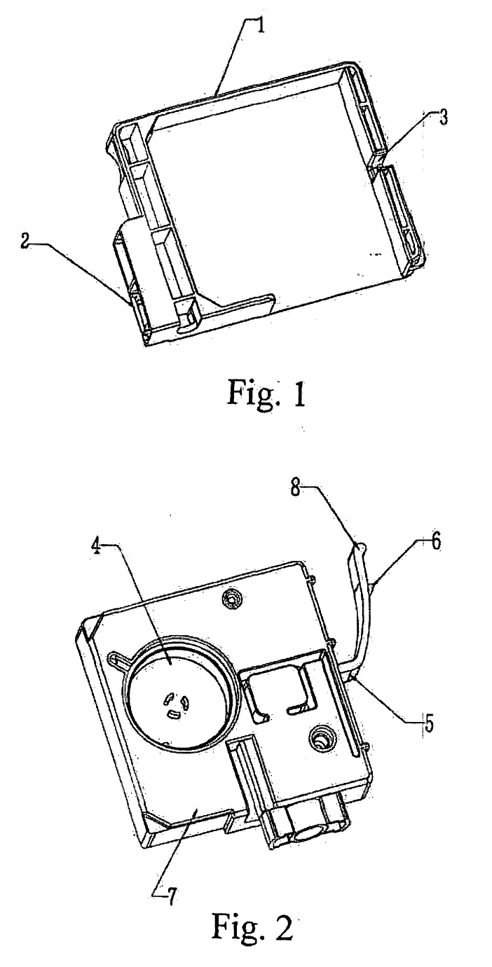

### DESCRIPTION OF EMBODIMENTS

The present invention is illustrated in detail below with reference to the accompanying drawings and the embodiment.

As shown in the figures, a chip position 2 and a locking structure 1a 3 are disposed on a shelf 1, a handle 8, a pressure control valve mechanism for precisely controlling an internal negative pressure, a locking structure 1b 5, a locking structure 2a 6 are disposed on an ink tank 7. The locking structure 1b 5 on the ink tank 7 and the locking structure 1a 3 on the shelf 1 are fitted, so as to realize the connection function. The locking structure 2a 6 on the ink tank 7 is fitted with the printer. The pressure control valve mechanism for precisely controlling the internal negative pressure on the ink tank is a check valve 4 which is composed of a valve membrane, a spring, and a valve body.

What is claimed is:

1. An ink cartridge for an inkjet printer, comprising an ink tank, a shelf, and a chip, wherein the ink tank has at least one handle, one of the handles has at least two locking structures, one of the locking structures fits the shelf, and the other locking structure fits the printer.

2. The ink cartridge for an inkjet printer as claimed in claim 1, wherein the ink tank has a pressure control valve mechanism for precisely controlling an internal negative pressure, the chip is fixed on the shelf, and the ink tank and the shelf are connected together with the locking structures.

3. The ink cartridge for an inkjet printer as claimed in claim 2, wherein the pressure control valve mechanism on the ink tank comprises a valve membrane, a spring, and a valve body.
